(19) United States
(12) Patent Application Publication
(10) Pub. No.: US 2006/0221295 A1
(43) Pub. Date: Oct. 5, 2006

(54) LCD HEATER SYSTEM

(75) Inventors: David A. Hein, Sterling Heights, MI (US); Robert M. Schmidt, Livonia, MI (US)

Correspondence Address: ARTZ & ARTZ, P.C., 28333 TELEGRAPH ROAD, SUITE 250, SOUTHFIELD, MI, 48034, US

(73) Assignee: LEAR CORPORATION, Southfield, MI (US)

(21) Appl. No.: 10/907,500

(22) Filed: Apr. 4, 2005

(51) Int. Cl. G02F 1/1333

(52) U.S. Cl. 349/161

(57) ABSTRACT

A flat panel display assembly (16) includes a flat panel display (28) and a heater (30). The heater (30) includes a heating trace (46) that is attached to and heats the flat panel display (28). A method of fabricating a flat panel display assembly includes forming a flat panel display (28). A flex circuit (30) with a heating trace (46) is applied to the flat panel display (28). Electrical conductors (52) are coupled to the heating trace (46) for current supply therethrough.

### TECHNICAL FIELD

The present invention relates to liquid crystal displays (LCDs) and the like and more particularly, to a technique for heating the same.

### BACKGROUND OF THE INVENTION

LCDs are utilized throughout industry for various purposes. With respect to the automotive industry, LCDs are often used to display information to a vehicle occupant. An LCD may, for example, be used to display navigation information or audio/video information.

An LCD typically consists of a pair of polarized panels with liquid crystals therebetween. The polarizing panels and the liquid crystals are applied to a piece of glass, which is mounted on a mirror or reflective substance. As an electric charge is applied to the liquid crystals they untwist allowing light to pass through the crystals. The amount of electric charge applied to the crystals adjusts the amount of light that is permitted to pass through the LCD. In operation, light passes through the first polarizing panel and the plane of vibration of the light is altered by the light crystals. When the angle of the light passing through the liquid crystals matches the angle of the second polarized panel the light is emitted from the LCD.

A current method of heating an LCD involves the incorporation of an Indium Tin Oxide (ITO) film that is screened onto the glass of the LCD. The ITO film performs as an electrode. As electrical current is applied to the ITO film the temperature of the LCD increases. It is desirable for an LCD display to heat up from −30° C. to 25° C. in approximately less than two minutes. Below approximately 10° C. the reaction of the liquid crystals tends to slow down and thus the LCD may operate inappropriately and/or have poor visual clarity.

ITO films are considered expensive and can have associated functional disadvantages. The ITO film when utilized is screened onto the LCD glass in layers. The layers provide a desired thickness to allow for warming of the LCD. Since indium tin oxide is generally a poor electrical conductor a significant amount of current must be applied to the ITO layers to increase the temperature of the LCD within the desired time frame. Thus, several layers of indium tin oxide are applied to the glass to provide the thickness to support the current applied and conduction necessary to heat the LCD in the required time frame.

The process of applying the ITO film is considered costly and time consuming, especially due to the number of layers that must be applied. Also, since the ITO film is screened onto the glass, degradation to the glass can occur in the screening process. In addition, the thicker the ITO film the less the amount of light that can be transmitted through the LCD, resulting in performance and clarity degradation.

Thus, there exists a need for an improved method of heating an LCD that provides quick heat-up times, is inexpensive, and does not have the above ITO film associated functional disadvantages stated above.

### SUMMARY OF THE INVENTION

In one embodiment of the present invention, a flat panel display (FPD) assembly is provided that includes a flat panel display and a heater. The heater includes a heating trace that is attached to and heats the flat panel display.

In another embodiment of the present invention, a method of fabricating a FPD assembly is provided that includes the forming of a flat panel display. A flex circuit having a heating trace is applied to the flat panel display. Electrical conductors are coupled to the heating trace for current supply therethrough.

The embodiments of the present invention provide several advantages. One such advantage is the provision of a flexible circuit coupled to an FPD. The incorporation of the flex circuit allows for efficient heating of the FPD. The application of a flex circuit to an FPD reduces manufacturing steps and time involved therein due to the application of a single thermal energy transfer layer to an FPD. A flex circuit provides a relatively thin and lightweight thermal energy transfer medium. The incorporation of a flex circuit also eliminates the need to screen ITO films or the like to the glass of an FPD, thereby, minimizing the potential for glass degradation. In addition, the use of a flex circuit minimizes light transmission degradation. The flex circuit is relatively thin in comparison to stacked layers of ITO film and this allows for an increased amount of backlighting to pass through an FPD.

Another advantage provided by an embodiment of the present invention is the provision of an FPD assembly that has a flex circuit with traces that are formed of a highly conductive material. The traces allow for efficient thermal energy transfer to and quick temperature increases of an FPD.

The present invention itself, together with further objects and attendant advantages, will be best understood by reference to the following detailed description, taken in conjunction with the accompanying drawing.

### BRIEF DESCRIPTION OF THE DRAWINGS

For a more complete understanding of this invention reference should now be had to the embodiments illustrated in greater detail in the accompanying figures and described below by way of examples of the invention wherein:

FIG. 1 is a perspective view of interior cabin of a vehicle incorporating flat panel display heater systems in accordance with an embodiment of the present invention.

FIG. 2A is a side block diagrammatic and cross-sectional view of an flat panel display heater system in accordance with an embodiment of the present invention.

FIG. 2B is a back view of the flat panel display heater system of FIG. 2A.

FIG. 3 is a method of fabricating a flat panel display assembly in accordance with an embodiment of the present invention.

### DETAILED DESCRIPTION

While the present invention is described primarily with respect to an LCD heater system and method of manufacturing the same, the present invention may be adapted to various flat panel displays having heating requirements. The present invention may be applied to displays within ground-based vehicles, aeronautical vehicles, watercraft, and to other vehicle and non-vehicle applications. The present invention may be applied to navigation system displays, audio and video displays, computer displays, rear view mirror displays, dashboard displays, console displays, instrument panel displays, as well as to other displays known in the art.

In the following description, various operating parameters and components are described for one constructed embodiment. These specific parameters and components are included as examples and are not meant to be limiting.

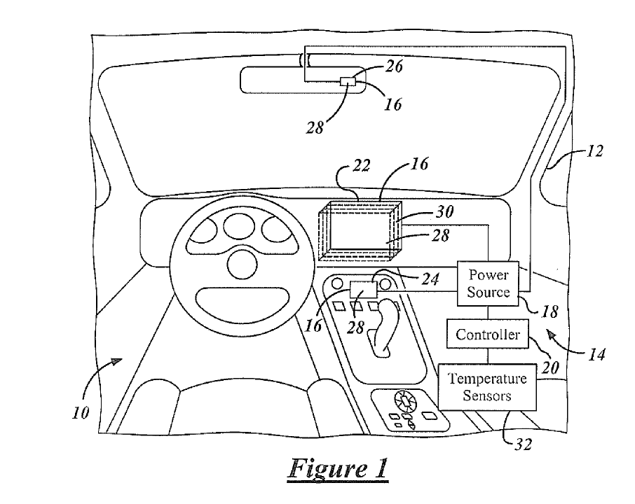

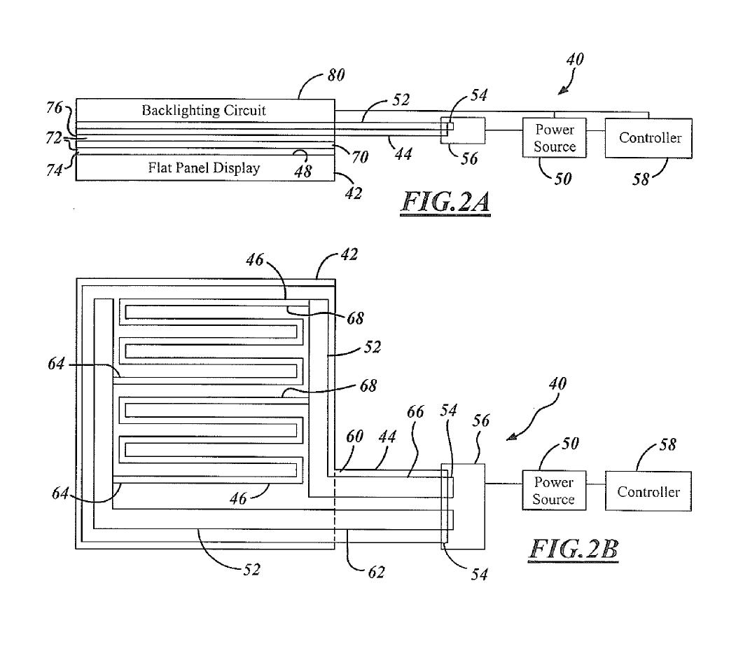

Referring now to FIG. 1, a perspective view of interior cabin 10 of a vehicle 12 incorporating flat panel display (FPD) heater systems 14 in accordance with an embodiment of the present invention is shown. The FPD heater systems 14 include FPD assemblies 16, which receive current from a power source 18 via a controller 20. Although the FPD assemblies 16 are shown as incorporating LCDs, other flat panel displays known in the art may be incorporated. Three FPD assemblies are shown; a navigation system FPD assembly 22, a stereo system FPD assembly 24, and a rear view mirror FPD assembly 26. The FPD assemblies 16 include the LCDs 28 and heaters 30 (only one heater is shown). The heaters 30 may be in the form of a flex circuits, as shown. The heaters 30 are utilized to heat the LCDs 28. A more detailed illustration of an FPD heater assembly can be seen with respect to the embodiment of FIGS. 2A and 2B.

The heaters 30 are applied to the backside of the LCDs 28 and are utilized to increase the temperature of the LCDs 28 to a desired operating temperature. It is desirable in one embodiment of the present invention to increase the temperature of the LCDs 28 from −30° C. to 25° C. in approximately less than two minutes.

The power source 18 is electrically coupled to the heaters 30 and the controller 20. The controller 20 is coupled to one or more temperature sensors 32. The temperature sensors 32 generate temperature signals indicative of the temperature within the interior cabin 10 and/or the individual temperatures of the LCDs 28. The controller 20 adjusts the current supplied to the 30 and thus the temperature of the LCDs 28 in response to the temperature signals.

The power source 18 may be of various types and styles known in the art. The power source 18 may be in the form of one or more batteries and may be shared among other vehicle systems or may be individually assigned to the FPD assemblies 16. The power source 18 may be in the form of a central vehicle power bus or power distribution device, a designated vehicle power bus or power distribution device, or other power source known in the art.

The controller 20 may be microprocessor based such as a computer having a central processing unit, memory (RAM and/or ROM), and associated input and output buses. The controller 20 may be an application-specific integrated circuit or may be formed of other logic devices known in the art. The controller 20 may be a portion of a central vehicle main control unit, an interactive vehicle dynamics module, a control circuit having a power supply, or may be in the form of one or more stand-alone controllers as shown.

The temperature sensors 32 may also be of various types and styles. Some example temperature sensors are bi-metal thermostat switches, solid-state thermostat switches, temperature gages, thermocouples, and thermistors. Other temperature measuring or sensing devices known in the art may also be used.

Referring now to FIGS. 2A and 2B, side and back block diagrammatic and cross-sectional views of an FPD heater system 40 in accordance with an embodiment of the present invention is shown. The FPD heater system 40 includes a FPD 42 and a heater 44 attached thereon. The heater 44 may also be in the form of a flex circuit and include heating traces 46, which extend across a backside 48 of and are used to increase the temperature of the FPD 42. A heating trace may refer to any conductive strip formed of a metallic material that extends on or within a portion of the heater 44 and is used as a heating element. A heating trace is not merely a signal or communication trace, but rather may be used to supply a significant amount of thermal energy. The heater 44 is coupled to a power source 50 via conductors 52, which extend from the traces 46 to the terminals 54 on a separate connector 56. The connector 56 is coupled to and receives current from the power source 50. The amount of current received is adjusted by the controller 58. The power source 50 and the controller 58 are similar to the power source 18 and the controller 20.

The heater 44 may be formed of various materials and includes the traces 46, which distribute current across and transfer thermal energy to the surface of the FPD 42. The traces 46 may be formed of various metallic materials including copper, aluminum, silver, or any other highly conductive materials known in the art or combination thereof. The traces 46 may be laminated or contained on or within a sheet 60. The sheet 60 may also be formed of various materials including plastic and polyester film, such as Mylar®, or may be in the form of an adhesive and/or other materials known in the art. The sheet 60 holds the traces 46 in a predetermined position and pattern.

Although, in the embodiment shown, two traces are utilized and each trace is in a continuous spiral pattern, any number of traces may be utilized and the traces may be in various patterns. The traces 46 may be resistive or in some other form as to increase in temperature or as to increase thermal transmission therefrom with applied current. Each trace 46 is coupled to a first conductor 62 at a first end 64 and to a second conductor 66 at a second end 68. The traces 46 form continuous current paths with the conductors 52.

The conductors 52 may be part of or may be attached separately to the heater 44, as shown. The conductors 52 may also be formed of copper, aluminum, silver, or any other highly conductive materials known in the art or combination thereof.

A diffusion layer 70 may be utilized, as shown, and reside between the heater 44 and the FPD 42. The diffusion layer 70 disperses or aids in the spreading of backlighting emitted through the FPD 42. The diffusion layer 70 may be formed of polycarbonate materials or other suitable diffusing material or combinations thereof.

The heater 44 and the diffusion layer 70 may be attached to the FPD 42 via one or more adhesive layers 72, as shown. In the sample embodiment shown, a first adhesive layer 74 resides between and attaches the diffusion layer 70 to the FPD 42. A second adhesive layer 76 resides between and attaches the heater 44 to the FPD 42. The heater 44 may be directly coupled to the FPD 42, although not shown. The adhesive layers 72 may attach the FPD 42, the heater 44, and the diffusion layer 70 at edges thereof, across the surface areas thereof, or otherwise as desired.

A backlighting circuit 80 may also be proximate, coupled, or attached to the heater 44, as shown. The backlighting circuit 80 may be coupled to the power source 50 and the controller 58. The backlighting circuit 80 illuminates the FPD 42. The backlighting circuit 80 may be in the form of a cold cathode fluorescent tube circuit, an LED array circuit, an incandescent light bulb circuit, an electroluminessence circuit, or other type of backlighting circuit known in the art.

Although the heater 44, the conductors 52, the diffusion layer 70, the adhesive layers 72, and the backlighting circuit are shown as being stacked and coupled in a particular order and configuration, they may be stacked or coupled in a different order and/or configuration. Also, any number of each may be utilized.

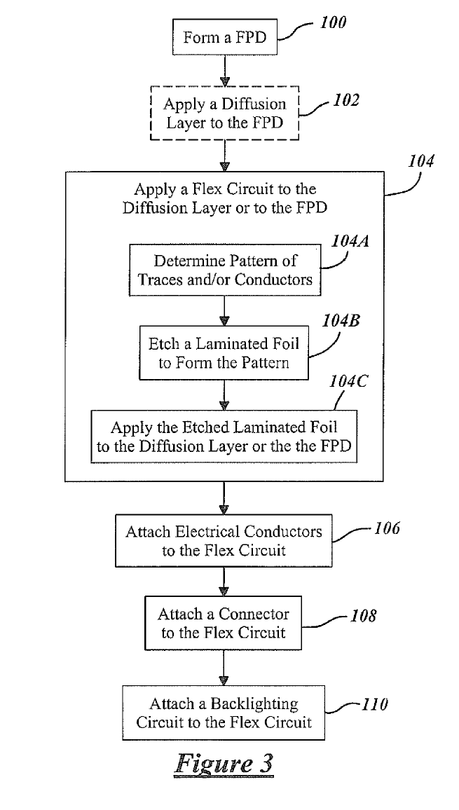

Referring now to FIG. 3, a method of fabricating an FPD assembly in accordance with an embodiment of the present invention is shown.

In step 100, a FPD is formed utilizing methods known in the art. As one non-all-inclusive LCD forming example, a pair of polarized panels and liquid crystals residing therebetween may be applied to a piece of glass. The glass may be mounted on a mirror or reflective substance. Of course, additional tasks may be performed in forming the FPD and the FPD may be formed using other techniques known in the art.

In step 102, a diffusion layer, such as the diffusion layer 70, may be applied to the backside of the FPD. The diffusion layer may be applied via an adhesive layer, such as the first adhesive layer 74.

In step 104, a heater having one or more traces, such as the heater 44 having the traces 46, is applied to the diffusion layer or to the FPD. In one example embodiment of the present invention, the heater is formed through the etching of a laminated metallic material. The laminated metallic material may be in the form of a laminated foil, such as a copper sheet or copper foil laminated in a polyester film.

In step 104A, a pattern for the traces and/or conductors that are to be contained within the heater is determined. The pattern, including the size, shape, quantity, and layout of the traces and conductors, may vary depending upon the application and the thermal requirements of that application. One example trace pattern is shown with respect to the embodiment of FIG. 2B. In step 104B, the laminated foil is etched to form the traces and/or conductors. Portions of the metallic foil are removed using etching techniques known in the art such that the traces and/or conductors remain on the corresponding laminating material, such as the laminating material provided in the above example. In step 104C, the etched and laminated metallic material is applied to the FPD. The etched material may be applied via an adhesive layer, such as the second adhesive layer 76.

In step 106, electrical conductors, such as the conductors 52, may be attached to the heater and thus to the traces. The conductors may be adhesively attached or attached using some other technique known in the art. The conductors are attached such that there is contact and thus good conductivity between the traces and the conductors.

In step 108, a connector, such as the connector 56, may be attached to the heater. The connector provides an easy coupling for attachment to an associated power source, such as the power source 50. In step 110, a backlighting circuit, such as the backlighting circuit 80, may be coupled or attached to the heater using methods known in the art.

The above-described steps are meant to be illustrative examples; the steps may be performed sequentially, synchronously, simultaneously, or in a different order depending upon the application.

The present invention provides a FPD assembly and method of forming the same that allows for the efficient heating of a FPD. The present invention reduces the number of manufacturing tasks involved and time to fabricate and assemble a FPD assembly. The present invention eliminates the need for the screening of thermally conductive films to the glass of a FPD for the heating thereof.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention, as defined by the appended claims.

What is claimed is:

1. A flat panel display assembly comprising:
a flat panel display; and
a heater comprising at least one heating trace attached to and heating said flat panel display.

2. An assembly as in claim 1 further comprising a plurality of electrical conductors electrically coupled to and supplying current to said at least one heating trace.

3. An assembly as in claim 1 further comprising:
a plurality of electrical conductors electrically coupled to said at least one heating trace; and
at least one connector electrically coupled to said plurality of electrical conductors.

4. An assembly as in claim 1 wherein said heater comprises a flex circuit that is applied to a backside of said flat panel display.

5. An assembly as in claim 1 wherein said at least one heating trace comprises at least one metallic trace that is applied across said flat panel display.

6. An assembly as in claim 1 wherein said at least one heating trace comprises at least one resistive trace that is applied across said flat panel display.

7. An assembly as in claim 1 wherein said at least one heating trace comprises a single continuous spiral trace that is applied across said flat panel display.

8. An assembly as in claim 1 further comprising a diffusion layer disposed between said flat panel display and said flex circuit, said diffusion layer spreading backlighting of said flat panel display.

9. An assembly as in claim 1 wherein said diffusion layer is adhesively attached to said flat panel display and said flex circuit.

10. An assembly as in claim 1 further comprising a backlighting circuit coupled to said flex circuit.

11. A flat panel display heater system comprising:
a flat panel display;
a flex circuit comprising at least one trace attached to said flat panel display;
a power source electrically coupled to said at least one trace; and
a controller electrically coupled to said power source and supplying current to said at least one trace to heat said flat panel display.

12. A system as in claim 11 further comprising:
a plurality of electrical conductors electrically coupled to said at least one trace; and
at least one connector electrically coupling said plurality of electrical conductors to said power source.

13. A system as in claim 11 wherein said flex circuit is applied to a backside of said flat panel display.

14. A system as in claim 11 wherein said at least one trace comprises at least one spiral trace that is applied across said flat panel display.

15. A system as in claim 11 wherein said at least one trace comprises a single continuous spiral trace that is applied across said flat panel display.

16. A system as in claim 11 further comprising a diffusion layer disposed between said flat panel display and said flex circuit, said diffusion layer spreading backlighting of said flat panel display.

17. A system as in claim 11 wherein said diffusion layer is adhesively attached to said flat panel display and said flex circuit.

18. A method of fabricating a flat panel display assembly comprising:
forming a flat panel display;
applying a flex circuit comprising at least one heating trace to said flat panel display; and
coupling electrical conductors to said at least one heating trace.

19. A method as in claim 18 further comprising:
applying a diffusion layer to said flat panel display via a first adhesive; and
applying said flex circuit to said diffusion layer via a second adhesive.

20. A method as in claim 18 wherein applying a flex circuit comprises:
etching a laminated metallic material; and
applying said laminated metallic material to said flat panel display.
